(19) United States
(12) Patent Application Publication
(10) Pub. No.: US 2026/0267128 A1
(43) Pub. Date: Sep. 10, 2026

(54) Method for Light-Field Microscopy and Light-Field Microscope

(71) Applicant: Carl Zeiss Microscopy GmbH, Jena (DE)

(72) Inventors: Thomas Egloff, Jena (DE); Stanislav Kalinin, Weimar (DE)

(21) Appl. No.: 19/555,068

(22) Filed: Mar. 3, 2026

(30) Foreign Application Priority Data
Mar. 5, 2025 (DE) 10 2025 108 431.9

(51) Int. Cl. G02B 21/36; G02B 3/00; G02B 21/02

(52) U.S. Cl. CPC G02B 21/367; G02B 3/0056; G02B 21/025; G02B 21/361

(57) ABSTRACT

Light-field microscopy including a) successively-acquiring image data sets of a sample using a light-field microscope at in each case different relative positions between a microscope objective of the light-field microscope and the sample, b) reconstructing a respective image stack of the sample from the various image data sets, c) in that the various relative positions in step a) are chosen on the basis of a dependence of a magnification of the light-field microscope on an axial coordinate which runs parallel to the optical axis, in such a way that adjacent image stacks overlap in part, and d) in that adjacent image stacks of the sample are combined to form a three-dimensional overall image of the sample on the basis of a dependence of a magnification of the light-field microscope on the axial coordinate.

The current application claims the benefit of German Patent Application No. 10 2025 108 431.9, filed on 3 Mar. 2025, which is hereby incorporated by reference.

The invention relates in a first aspect to a method for light-field microscopy according to the preamble of claim 1 and in a second aspect to a light-field microscope according to the preamble of claim 21.

A generic method and a generic light-field microscope are known for example from DE 10 2022 128 078 A1.

In a generic method of light-field microscopy, the following method steps are performed: a) image data sets of a sample are successively acquired using a light-field microscope at in each case different relative positions between a microscope objective of the light-field microscope and the sample, b) a respective image stack of the sample is reconstructed from each of the different image data sets.

A generic light-field microscope comprises at least the following constituent parts: a light source for providing illumination light, an illumination beam path for guiding the illumination light into a sample region, a two-dimensionally spatially resolving detector for detecting detection light coming from a sample in the sample region, a detection beam path with a microscope objective and a multi-lens array for guiding the detection light to the detector, a displacement device for adjusting a relative position between the sample and the microscope objective in the direction of an optical axis of the microscope objective and/or in the direction of at least one lateral direction perpendicular thereto and a control unit for controlling the displacement device and for evaluating measurement data from the detector. The control unit is configured A) to control the displacement device in such a way that image data sets of the sample are successively acquired for in each case different relative positions between the microscope objective and the sample, and B) to reconstruct a respective three-dimensional image stack of the sample from the individual image data sets.

Light-field microscopy has been the subject of increasing discussion in recent years in relation to simultaneous three-dimensional fluorescence microscopy. In this context, a multi-lens array upstream of the camera is used to simultaneously acquire location and angle information in a single camera image, and so the volume information can be inferred from this data.

So-called Fourier light-field microscopy has turned out to be a variant of light-field detection that is preferred for microscopy. In this case, the multi-lens array is arranged in a plane conjugate to the back focal plane of the microscope objective. A multiplicity of real images, each corresponding to a different viewing direction of the sample, are then created simultaneously on the camera chip. Then, using known methods, a three-dimensional image stack of a sample can be reconstructed from this multiplicity of simultaneously acquired images, which may be referred to as an image data set.

The field of view and, related therewith, the volume of a reconstructed image stack may be perceived as inadequate for larger samples. Like in other imaging methods, multiple image data sets must be acquired successively at different relative positions between the sample and the microscope objective in this case.

In the two-dimensional case, the individually acquired images are also referred to as tiles, which are generally combined with one another by software in such a way that possible deviations between the tiles are corrected.

Deviations between the individual tile images may be caused by e.g. inaccuracies in the lateral and/or axial positioning of the sample relative to the microscope objective. The term “stitching” has also become established for the process of combining the individual images. In the two-dimensional case, stitching of images is a generally well-established method.

The lateral and/or the axial coordinates of the individual images can be corrected on the basis of the image data themselves, generally by correlating the overlapping regions of the adjacent tiles and determining the respective offset in the lateral and/or the axial coordinates.

In contrast to three-dimensional image stacks acquired using a wide-field or laser scanning microscopy (LSM) system, image stacks are generally not telecentric in light-field microscopy. That is to say, the magnification generally depends on the axial coordinate and consequently on the distance of a sample plane from the microscope objective. Since mismatches resulting from different magnifications cannot easily be corrected by displacing tiles, hitherto known stitching methods cannot be used for stitching light field data in z.

Stitching images from the image stacks obtained using a light-field microscope in the lateral coordinates is theoretically possible if the displacements are determined independently for each two-dimensional image in an image stack. In practice, this may lead to artefacts, for instance if some of the two-dimensional images do not contain high-contrast structures in the overlapping regions, and an offset necessary for correct stitching cannot be reliably determined.

In addition to the errors caused by lack of telecentricity, three-dimensional image stacks generated by a light-field microscope also have a different scaling of the axial coordinate in comparison with those image stacks that were recorded by scanning in the axial coordinate, for example using a laser scanning microscope. This effect is attributable to the generally different refractive indices of an immersion medium and of an embedding medium in which the sample is received. If these differences in the scaling of the axial coordinate are not corrected when acquiring image data sets for different axial relative positions between the microscope objective and the sample, then the stitching cannot be carried out correctly.

A problem addressed by the invention can be regarded as that of specifying a method for light-field microscopy and a light-field microscope, which allow the acquisition of volume images of a sample which are composed of multiple three-dimensional image stacks.

According to the invention, this problem is solved by the method having the features of claim 1 and by the light-field microscope having the features of claim 21.

According to the invention, the method of the aforementioned type is developed in that c) the various relative positions in step a) are chosen on the basis of a dependence of a magnification of the light-field microscope on an axial coordinate which runs parallel to the optical axis, in such a way that adjacent image stacks at least overlap in part, and d) in that adjacent image stacks of the sample are combined to form a three-dimensional overall image of the sample on the basis of a dependence of a magnification of the light-field microscope on the axial coordinate.

According to the invention, the light-field microscope of the aforementioned type is developed in that the control unit is furthermore configured C) to control the displacement device on the basis of a dependence of a magnification of the light-field microscope on an axial coordinate which runs parallel to the optical axis, in such a way that adjacent image stacks in the various relative positions in step A) overlap in part, and D) to combine adjacent image stacks of the sample to form a three-dimensional overall image of the sample on the basis of a dependence of a magnification of the light-field microscope on the axial coordinate.

Advantageous variants of the method according to the invention and preferred exemplary embodiments of the light-field microscope according to the invention are explained below, in particular with reference to the dependent claims and the figures.

By preference, the method according to the invention or variants of the method according to the invention are performed using a light-field microscope according to the invention or any of the exemplary embodiments of a light-field microscope according to the invention described herein.

The light-field microscope according to the invention or any of the exemplary embodiments of the light-field microscope according to the invention as described herein, in particular the control unit, are preferably configured to perform the method according to the invention or any of the variants of the method according to the invention described herein.

The light source can be implemented by any light source capable of supplying the illumination light with a desired spectral composition and with a suitable intensity. For example, the light source might be a laser, a plurality of lasers, an LED, an LED module or a combination of these components. The illumination light can be coherent or at least partially coherent illumination light.

The illumination light is electromagnetic radiation, in particular in the visible spectral range and in adjoining ranges. The illumination light can also be referred to as excitation light; these two terms are used synonymously for the most part in this description.

The term illumination beam path in particular denotes beam-guiding and beam-modifying components, e.g. lenses, mirrors, prisms, gratings, filters, stops, beam splitters, by means of which and via which the illumination light is guided from the light source to the sample to be examined. The only demand placed on the contrast-providing principle by the present invention is that the sample emits detection light as a consequence of the irradiation by the excitation light.

The term sample region or sample space denotes the spatial region in which a sample to be examined can be arranged. In typical embodiments, a sample, e.g. by means of a sample holder or a sample frame, can be positioned or secured on an xy-stage which is adjustable in lateral directions with respect to an optical axis. A z-drive can be present to modify the distance between the sample stage and a microscope objective.

In principle, the sample can be any kind of sample. The light-field microscope according to the invention and the method according to the invention are suitable for examining biological samples in particular.

The two-dimensionally spatially resolving detector may comprise one or more of the following elements or following components: CCD element, CMOS element, SPAD element. The sensor plane of the detector is the plane in which the detection light is detected.

Detection light is light emitted by the sample to be examined, in particular as a consequence of said sample being irradiated by the illumination light. In order for the light to be able to be referred to as detection light, it is only necessary that the light is emitted by the illuminated sample or that in any case it comes from the illuminated sample. The detection light may also be referred to as emission light. The detection light may also be deflected, scattered or reflected excitation light. Typically, the detection light is fluorescence which the sample, in particular dye molecules present there, emits or emit as a consequence of being irradiated with the illumination light.

The term detection beam path in particular denotes beam-guiding and beam-modifying optical components, for example objectives, lenses, mirrors, prisms, gratings, filters, stops, beam splitters, modulators, for example spatial light modulators (SLM), by means of which and via which the detection light is guided from the sample to be examined to the detector. The microscope objective is part of the detection beam path. The microscope objective associated with the detection beam path may also be part of the illumination beam path. The illumination beam path may also have a separate microscope objective.

The optical axis of the detection beam path is given by the optical axis of the microscope objective. Commercially available microscope objectives may be used, in principle. In order to avoid overlap or crosstalk between individual partial images, a field stop that limits the size of the partial images in the sensor plane can advantageously be arranged in an intermediate image plane of the detection beam path.

The multi-lens array serves to image light emitted by a sample onto the detector. The term multi-lens array refers to an arrangement of a plurality of lenses in a plane, wherein the optical axes of the individual lenses are generally parallel to one another. However, this is not mandatory. In particular, the individual lenses may all have the same size and the same focal length, but this is not mandatory either. The lenses of the multi-lens array can be microlenses, in particular, and the multi-lens array can also be referred to as a microlens array.

For example, the displacement device for adjusting a relative position between the sample and the microscope objective can be realized by an xyz-displacement stage, in the case of which the z-axis extends in the direction of the optical axis of the microscope objective.

Alternatively, the displacement device may also comprise a device for axially displacing a microscope optics unit relative to the sample and an xy-displacement stage.

The term pupil plane denotes a plane which is perpendicular, in particular with respect to the optical axis of the illumination beam path or of the detection beam path, and which is optically conjugate to a back focal plane of the respective microscope objective. The term intermediate image plane denotes a plane which is perpendicular, in particular with respect to the optical axis of the illumination beam path or of the detection beam path, and which is optically conjugate to an image plane of the respective microscope objective.

A partial image refers to an individual image generated by an individual lens of the multi-lens array in the sensor plane of the detector. The totality of the images generated simultaneously by lenses of the multi-lens array in the sensor plane of the detector is referred to as an image data set. Thus, each image data set of the sample consists of a set of partial images.

The term control unit denotes all hardware and software components which interact with the components of the light-field microscope according to the invention for the intended function thereof. In particular, the control unit can comprise a computing device, for example a PC, and a camera controller. The computer resources of the control unit can be distributed among multiple computers and optionally a computer network, in particular also via the Internet. The control unit can have in particular customary operating devices and peripherals, such as mouse, keyboard, screen, storage media, joystick, Internet connection. The control unit can in particular read the image data from the detector and can also be configured and serve to control the light source.

The axial coordinate direction z is the direction of the optical axis. The two coordinate directions x and y perpendicular to the axial coordinate direction z are referred to as lateral coordinate directions.

The reconstruction method step comprises generating a respective three-dimensional image stack of the sample from an individual image data set. In essence, known methods are used for this purpose. Each image stack may consist of multiple images, each at a different depth in the direction of the optical axis of the microscope objective, wherein the images in particular extend perpendicular to the optical axis in each case.

The feature whereby adjacent image stacks overlap at least in part means that the respective volumes of the adjacent three-dimensional image stacks acquired have at least one partial region in common.

If this description refers to a first image stack and a second image stack overlapping in a coordinate direction, then this means that an interval over which the first image stack extends in the coordinate direction overlaps with an interval over which the second image stack extends in the coordinate direction; i.e. these two intervals are either identical or have a non-vanishing intersection interval.

A first essential concept of the present invention can be regarded as that of setting the different relative positions between sample and microscope objective, which are set for the purpose of acquiring the individual image data sets, on the basis of a dependence of a magnification of the light-field microscope on the axial coordinate.

A further essential concept of the present invention can be considered that of assembling the three-dimensional image stacks reconstructed from the individual image data sets likewise on the basis of a dependence of the magnification of the light-field microscope on the axial coordinate.

The capability of very quickly obtaining accurate three-dimensional images of large samples can be regarded as an essential advantage of the present invention.

In principle, it is possible that the multi-lens array is arranged upstream of the detector in a plane optically conjugate to a focal plane of the microscope objective, or in the vicinity of such a plane. Such an arrangement realizes a light-field microscope which is also referred to as a spatial-domain light-field microscope.

By preference, the multi-lens array is arranged upstream of the detector in a plane optically conjugate to a back focal plane of the microscope objective, i.e. in a pupil plane, or in the vicinity of such a plane. Such an arrangement realizes a light-field microscope which is also referred to as a Fourier light-field microscope.

There are multiple options for determining the dependence of the magnification on the axial coordinate.

In a first variant of the method according to the invention, the dependence of the magnification on the axial coordinate is calculated from optical parameters of the light-field microscope and/or the sample.

The optical parameters of the light-field microscope may include one or more of the following parameters:
the refractive index of an embedding medium in which the sample is received,
the magnification of the microscope objective,
the numerical aperture of the microscope objective,
the axial distance of a sample-side exit lens of the microscope objective from the sample,
the refractive index of an immersion liquid,
parameters of the geometric arrangement of a multi-lens array.

It is also possible that parameters of the sample or information about the sample, in particular a refractive index of an embedding medium for the sample, are input by a user before the dependence of the magnification on the axial coordinate is calculated.

In a second variant of the method according to the invention, the dependence of the magnification on the axial coordinate is determined using a calibration sample, the size of which is known and/or which comprises structures of known size, at multiple different axial distances of the microscope objective relative to the calibration sample. For example, a grating with a known grating period can be used as the calibration sample.

In a second variant of the method according to the invention, the dependence of the magnification on the axial coordinate is determined by analysis of axially and laterally overlapping images.

For example, the following method steps can be performed in the process:
searching for structures, which correspond to each other, in images of image stacks that axially overlap in part,
determining differences in the magnification for different axial depths of a found structure by comparing the size of this structure in images belonging to image stacks that differ in terms of their axial pose,
determining the dependence of the magnification on the axial coordinate from differences in the magnification obtained for different axial depths of the respective structure.

In addition to that or in an alternative, the following method steps may also be performed to ascertain the dependence of the magnification on the axial coordinate:
searching for structures, which correspond to each other, in images that overlap laterally and axially,
determining a lateral displacement of structures, which correspond to each other, by correlating the image information in the overlapping images,
determining the dependence of the magnification on the axial coordinate by determining the dependence of the magnitude of the lateral displacements on the axial coordinate.

By preference, high-contrast images are used in the image evaluation for determining the dependence of the magnification on the axial coordinate.

It was found that, in practice, a linear relationship can be assumed for the dependence of the magnification on the axial coordinate, in accordance with the theoretical expectation.

In a particularly preferred variant, different methods for determining the dependence of the magnification on the axial coordinate are combined. For example, a dependence of the magnification on the axial coordinate calculated from optical parameters of the light-field microscope and/or of the sample can be verified or refined by analysis of images that overlap axially and laterally.

In a particularly preferred variant of the method according to the invention the different relative positions are chosen in step c) in such a way that adjacent image stacks overlap at least in part in an axial coordinate and that wherever the adjacent image stacks overlap in the axial coordinate, they overlap at least in part in both lateral coordinates perpendicular to the axial coordinate. Accordingly, the control unit in the light-field microscope according to the invention is preferably configured to control the displacement device in such a way that the stated requirements in relation to the overlap are met for respective adjacent image stacks. If all image stacks completely overlap one another axially, i.e. in the case of purely lateral volume scans, this may ensure that the volumes arising due to the overlap of the image stacks are convex. This means that given any pair of points in the volume, the connecting line between these points likewise lies within the volume.

The sequential performance according to the invention of multiple acquisitions of the sample for different relative positions between the sample and the microscope objective may be referred to as a volume scan. In a first preferred variant of a volume scan of a sample, a relative position between the sample and microscope objective is changed in the coordinates perpendicular to the optical axis. Such volume scans may be referred to as lateral volume scans if the relative position between the sample and the microscope objective is only changed in the coordinates perpendicular to the optical axis.

In a second preferred variant of a volume scan, a relative position between the sample and the microscope objective is changed in the axial coordinate parallel to the direction of the optical axis. Such volume scans may be referred to as axial volume scans if the relative position between the sample and the microscope objective is only changed in the axial coordinate.

If the relative position between the sample and the microscope objective is changed at least also in the axial coordinate between the acquisition of individual data sets during a volume scan, then it is necessary to account for the situation described at the outset whereby the scaling of a reconstructed image stack generally differs from the scaling of an axial displacement of the light-field microscope.

In a preferred variant of the method according to the invention, a calibration relationship is determined between an axial scaling of a reconstructed image stack and an axial scaling of an axial displacement of a displacement device for adjusting an axial distance between the sample and the microscope objective.

Advantageously in that case, the axial scaling of the reconstructed image stack can be calibrated using the ascertained calibration relationship. In this case, the calibration of the axial scaling in the reconstructed image stacks may be performed following the reconstruction of the three-dimensional images or else already in the course of the reconstruction of the three-dimensional images.

Alternatively, it is also possible for the axial scaling of the axial displacement of the displacement device to be calibrated using the ascertained calibration relationship.

In accordance with the theory, a proportional relationship between the scaling of the axial displacement of the displacement device and the axial scaling of reconstructed image stacks may be assumed for the calibration relationship. Ascertaining the calibration relationship thus substantially consists in determining the constant of proportionality between the axial scaling of the axial displacement and the axial scaling of the image stacks. There are multiple possibilities to this end.

In a first preferred variant of the method according to the invention, the calibration relationship is calculated from optical parameters of the light-field microscope and/or the sample.

The optical parameters of the light-field microscope used for this purpose may include one or more of the following parameters:
the refractive index of an embedding medium in which the sample is received,
the magnification of the microscope objective,
the numerical aperture of the microscope objective,
the axial distance of a sample-side exit lens of the microscope objective from the sample,
the refractive index of an immersion liquid,
parameters of the geometric arrangement of a multi-lens array.

Like for the determination of the dependence of the magnification on the axial coordinate, parameters of the sample or information about the sample, in particular a refractive index of an embedding medium for the sample, can be input by a user before the calibration relationship is calculated.

In a second preferred variant of the method according to the invention, the calibration relationship is determined by analysis of axially and laterally overlapping images. In this context, high-contrast images are preferably used for the image evaluation.

In a third preferred variant of the method according to the invention, the calibration relationship is ascertained using a calibration object which has axial structuring of known size and by reconstruction of image stacks acquired at different axial distances of the microscope objective relative to the calibration object.

Advantageously, different methods for ascertaining the calibration relationship can be combined. For example, a calibration relationship calculated from optical parameters of the light-field microscope and/or of the sample can be verified or refined by analysis of images that overlap axially and laterally.

To correctly combine laterally adjacent images, it is necessary for images of a first image stack to be combined in each case with an axially correctly positioned image of an adjacent second image stack. Axially correctly positioned means that the images to be combined must in each case lie in the same axial plane and consequently must originate from the same axial plane of the sample so that a correct volume image of the sample is ultimately obtained. The term axial plane refers to planes which intersect the axial direction at right angles at a specific axial coordinate. Thus, in method step d), respective images of a first image stack are combined with a respective image of an adjacent second image stack that belongs to the same axial plane in the sample as the respective image of the first image stack. For axially completely overlapping adjacent image stacks this means that, in method step d), respective images of the first image stack are combined with images of the adjacent second image stack which are in each case located at the same axial depth in relation to the image stack.

So that adjacent images can be combined correctly, these images must in each case be displaced relative to each other by the correct amount. Measured in physical units of length (nm, μm, mm, . . . ), this displacement is independent of the axial coordinate. The fact that the magnification depends on the axial coordinate, as described at the outset, means that the respective displacement required for combining adjacent images, as measured in pixels, depends on the axial coordinate. A particularly preferred exemplary embodiment of the method according to the invention is distinguished in this context in that in order to combine a first image in a first image stack with a second image which is in an adjacent second image stack and in particular located at the same axial depth in relation to the respective image stack, the first image and the second image are displaced relative to each other by a lateral displacement that corresponds to the different relative position between the sample and the microscope objective when acquiring the image data set for the second image stack in comparison with the acquisition of the image data set for the first image stack, and in that the lateral displacement measured in pixels is calculated using the dependence of the magnification on the axial coordinate. The lateral displacement measured in pixels can be calculated and carried out for all images in the first image stack and in the second image stack.

If the nominal displacements in the x-direction and in the y-direction transmitted to the displacement device by way of the control unit were to correspond exactly to the actual displacements, then these nominal displacements could simply be used to displace adjacent images, which should be combined with each other, by the correct amount relative to one another. However, this is not possible for two reasons. Firstly, the respective shifts have to be performed in pixels and hence have to be converted into units of pixels.

Moreover, the displacement device generally has inaccuracies which have the effect that a displacement to be actually performed in the x-direction does not correspond to the nominal displacement in the x-direction, and a displacement to be actually performed in the y-direction does not correspond to the nominal displacement in the y-direction. This means that the nominal displacements in the x-direction and in the y-direction have to be provided with a correction. Measured in pixels, this correction in turn depends on the axial coordinate.

The fact that the magnification depends linearly on the axial coordinate was explained above. This means that a linear approach in the two lateral coordinates can also be chosen for the lateral displacement, measured in pixels, in the x-direction and in the y-direction:

$$Offsetx ( z ) [ p ] = Offsetx ( z = 0 ) [ l . u ] / ( {β}_{x} ( z = 0 ) [ l . u . / p ] + a [ l . u . / p \cdot l . u . ] \cdot z [ l . u . ] ) \qquad ( 1 )$$

$$Offsety ( z ) [ p ] = Offsety ( z = 0 ) [ l . u ] / ( {β}_{y} ( z = 0 ) [ l . u . / p ] + b [ l . u . / p \cdot l . u . ] \cdot z [ l . u . ] ) \qquad ( 2 )$$

In this case:
Offsetx(z) denotes the real displacement, measured in pixels, in the direction of the x-axis for an image in the plane with the axial coordinate z
Offsety(z) denotes the real displacement, measured in pixels, in the direction of the y-axis for an image in the plane with the axial coordinate z
[p] denotes units of pixel
[l.u.] denotes units of length
βₓ(z=0) denotes the scale in the plane z=0 in units of length per pixel in the x-direction
β_{y}(z=0) denotes the scale in the plane z=0 in units of length per pixel in the y-direction
a, b denotes the constant of proportionality for the change in the imaging scale dependent on the z-position in lateral units of length per pixel per axial unit of length

Offsetx(z=0) denotes the nominal displacement in the x-direction converted into pixels for the plane z=0, and Offsety(z) denotes the nominal displacement in the y-direction converted into pixels for the plane z=0.

Should the optical system be rotationally symmetric in relation to the axial coordinate, which generally is the case, then a=b and βₓ(z=0)=β_{y}(z=0)=β. This means that only the four parameters Offsetx(z=0), Offsety(z=0), a and β need to be determined in order to determine the displacements overall. This brings about a considerable simplification in comparison with solutions known from the prior art. For cases in which only lateral volume scans are performed and the different magnifications and consequently the different pixel grids at different axial depths of an image stack are acceptable, this provides a comparatively uncomplicated combination method. If a and b are comparatively small, Offsetx(z) and Offsety(z) depend approximately linearly on Z.

In a further particularly preferred variant of the method according to the invention, a pixel grid of the images in an image stack is rescaled in such a way using the dependence of the magnification on the axial coordinate that the number of pixels per unit area is the same for all images in this image stack. This rescaling may be performed following the reconstruction of the three-dimensional images or already in the course of the reconstruction of the three-dimensional images.

This rescaling is mandatory in the case of volume scans which acquire image data sets for which the relative positions between the sample and the microscope objective differ in the axial distance of the sample from the microscope objective, i.e. in the case of axial volume scans in particular. Otherwise, images of adjacent image stacks located at the same absolute axial depth could not be combined with one another on account of the different pixel grid in each case.

If a first image belonging to a first image stack should be combined with a second image belonging to a second image stack and if these images to be combined have the same pixel density, i.e. the same number of pixels per unit area, or the same pixel pitch, then following the implementation of the correct displacement required for the combination, the pixel grids of the two images will in general not lie on top of one another but rather will be displaced relative to one another. In order to implement the combination in that case, it is expedient to match the pixel grid of the first image belonging to the first image stack to the pixel grid of the adjacent second image, to be combined with the first image, by interpolation between measured pixel values reconstructed for the first image stack, in such a way that the first image and the second image have a congruent pixel grid in a lateral relative position correct for the combination. Congruent pixel grids mean those pixel grids in which the pixels are each case located on points of the same two-dimensional grid.

The pixel grids of adjacent images, to be combined, of different image stacks can in particular be matched in this way for images for which a rescaling, as described above, has been performed beforehand.

Further advantages and features of the method according to the invention and of the light-field microscope according to the invention are explained below in association with the attached figures, in which:

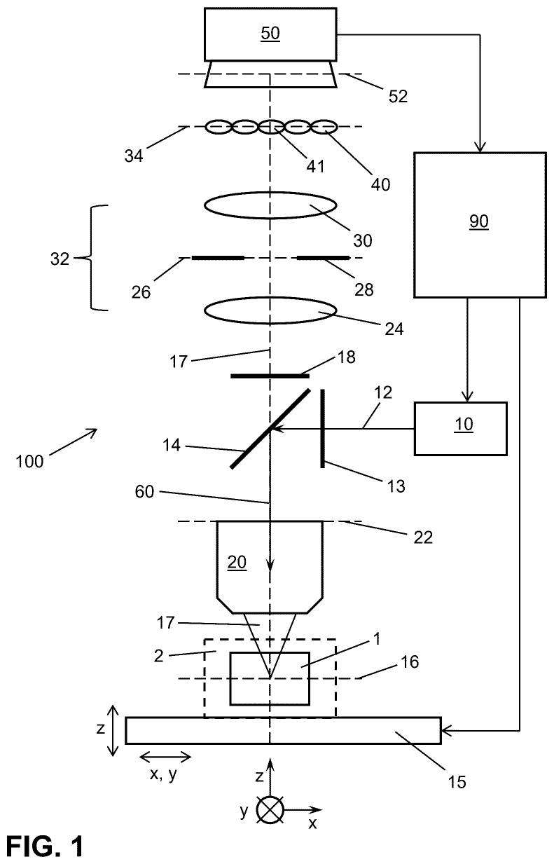

FIG. 1: shows an exemplary embodiment of the light-field microscope according to the invention;

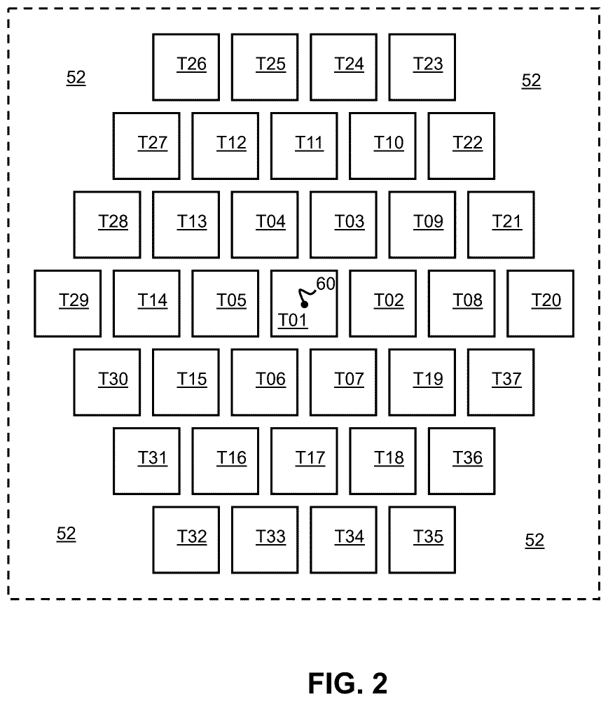

FIG. 2: shows an example of a set of partial images in a sensor plane of the detector;

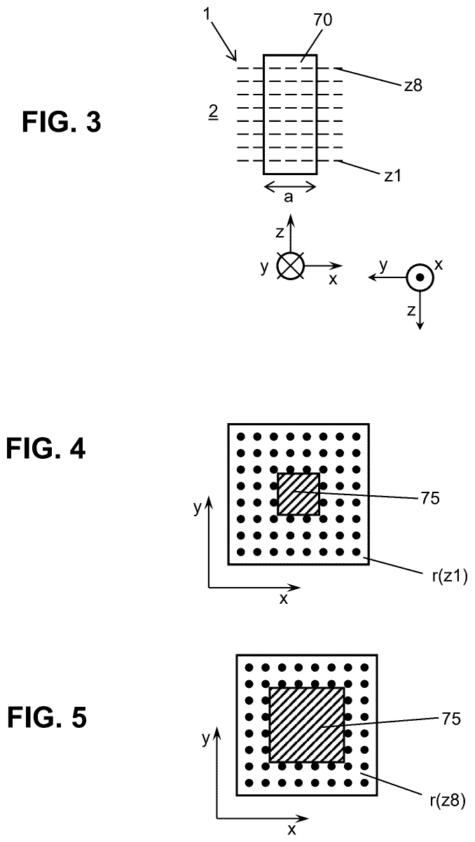

FIG. 3: shows a schematic illustration of a test object for explaining the circumstances of the magnification of the light-field microscope, which depends on the axial coordinate z;

FIG. 4: shows an illustration of a reconstructed image with the test object in a first axial plane z1;

FIG. 5: shows an illustration of a reconstructed image with the test object in a second axial plane z8;

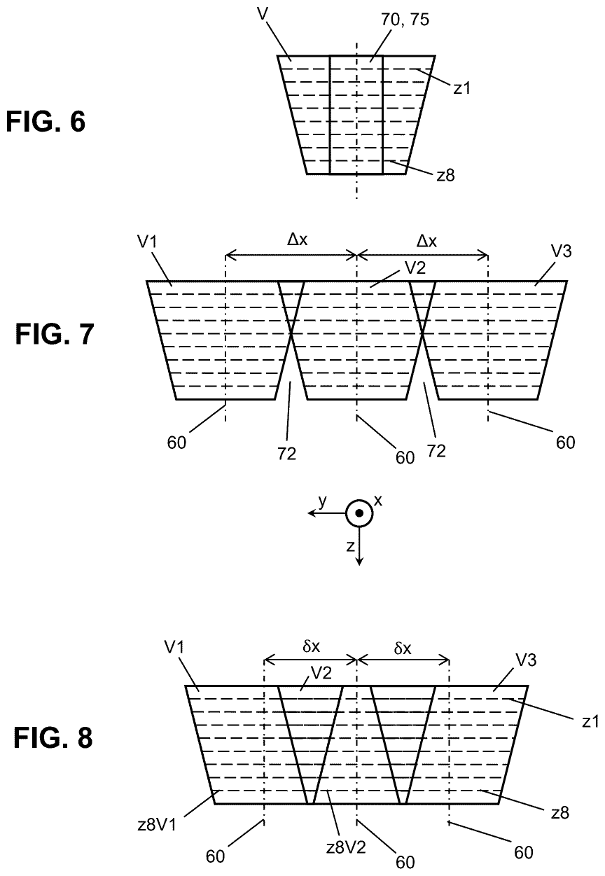

FIG. 6: shows a schematic illustration of a reconstructed image stack;

FIG. 7: shows a schematic illustration of a first example of a sequence of successively recorded image stacks in a lateral volume scan;

FIG. 8: shows a schematic illustration of a second example of a sequence of successively recorded image stacks in a lateral volume scan;

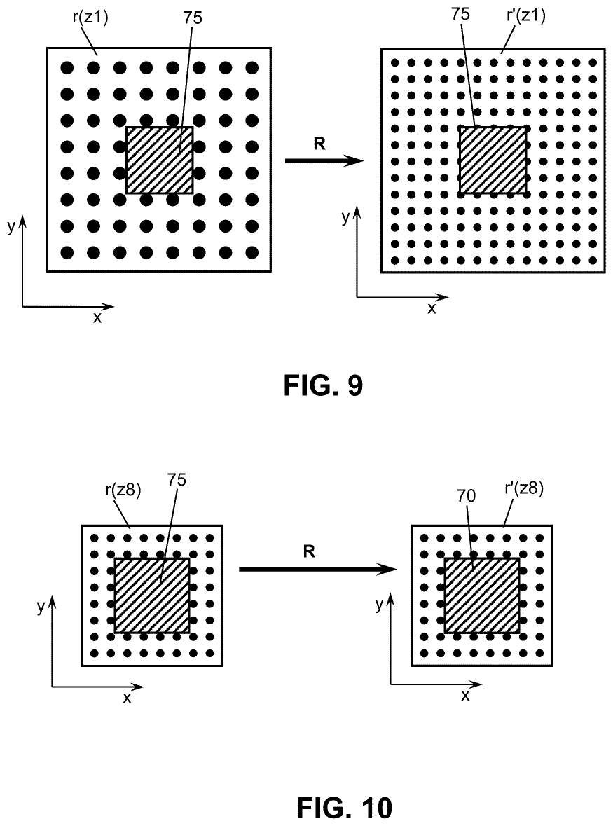

FIG. 9: shows an illustration of a rescaling of the image shown in FIG. 4;

FIG. 10: shows an illustration of a rescaling of the image shown in FIG. 5;

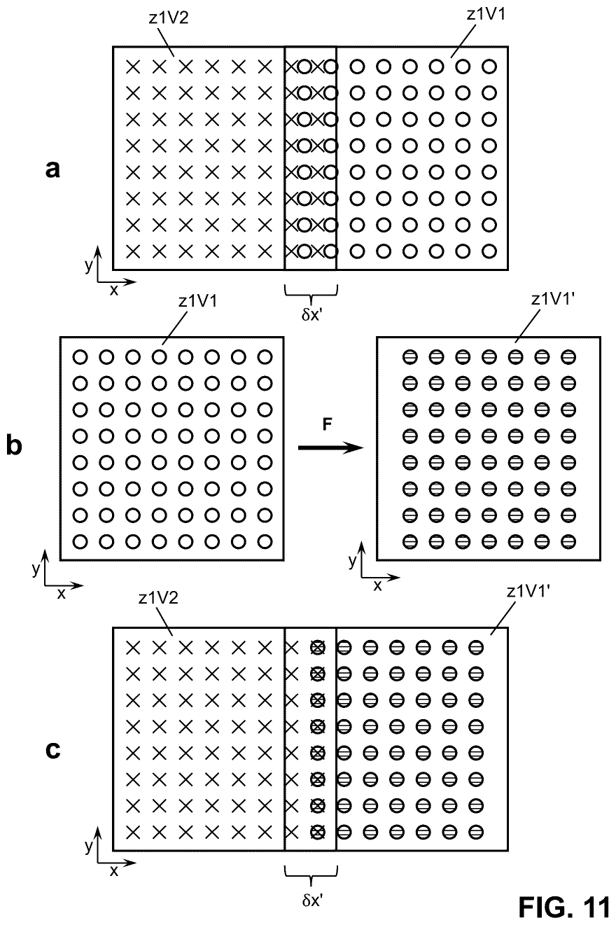

FIG. 11: shows an illustration of generating a congruent pixel grid for adjacent images to be combined;

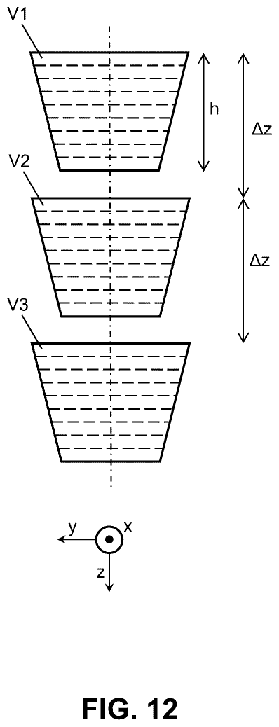

FIG. 12: shows an illustration of the circumstances in the case of an axial volume scan and

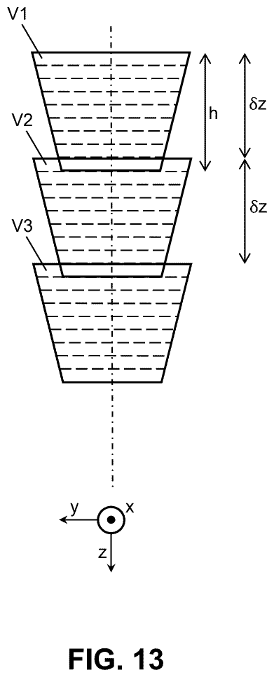

FIG. 13: shows a schematic illustration of an example of a sequence of successively recorded image stacks in an axial volume scan.

Identical and identically acting components are generally provided with the same reference signs in the figures.

An exemplary embodiment of a light-field microscope 100 according to the invention will be explained with reference to FIGS. 1 and 2. FIG. 1 schematically shows the light-field microscope 100 according to the invention. FIG. 2 schematically shows the arrangement of partial images T01 to T37 in a sensor plane 52 of a detector 50 of the light-field microscope 100.

According to the invention, the light-field microscope 100 initially comprises a light source 10, for example a laser or a laser module, for providing illumination light 12 and an illumination beam path for guiding the illumination light 12 into a sample region 2.

In the exemplary embodiment shown, the illumination beam path comprises an excitation filter 13, a main beam splitter 14 and a microscope objective 20. At least some of the illumination light 12 is initially transmitted through the excitation filter 13 and subsequently reflected off the main beam splitter 14, typically a dichroic beam splitter, in the direction of the microscope objective 20, which guides the illumination light into the sample space 2, in particular into a focal plane 16 of the microscope objective 20.

A sample 1, for example a biological preparation, is arranged in the sample region 2 and, for example, possibly accommodated in an embedding medium and arranged on a sample carrier. According to the invention there is a displacement device 15, an xyz-displacement stage in the exemplary embodiment shown, by means of which the sample region 2 and hence the sample 1 can be moved in the direction of an optical axis 60 of the microscope objective 20, which coincides with the z-axis, and, independently thereof, in the two lateral coordinate directions x and y perpendicular to the z-axis. In FIG. 1, these coordinate directions are indicated by a coordinate system. The displacement device 15 serves to set the desired relative position between the sample 1 and the microscope objective 20 for the purpose of acquiring an image data set. The displacement device 15 can be controlled by the control unit 90, which is present according to the invention. In the exemplary embodiment shown, the control unit 90 is also configured to control the light source 10.

To detect detection light 17 emitted by the sample 1, especially as a consequence of the latter being irradiated by the illumination light 12, the light-field microscope 100 moreover comprises the two-dimensionally spatially resolving detector 50, for example a camera, and a detection beam path, which serves to guide the detection light 17 onto the detector 50. The detection light 17 may in particular be fluorescence from dyes used to prepare the sample 1. According to the invention, the detection beam path comprises the microscope objective 20 and a multi-lens array 40, the latter being arranged in a plane 34 optically conjugate to a back focal plane 22 of the microscope objective 20 in the exemplary embodiment shown. For example, the detector 50 can be realized by a CCD camera, a CMOS camera or a SPAD camera.

In the exemplary embodiment depicted in FIG. 1, the detection beam path furthermore comprises a main beam splitter 14, an emission filter 18, a tube lens 24, which realizes a first lens of a relay optics unit 32, and a further lens 30, which realizes a second lens of the relay optics unit 32. The main beam splitter 14 serves to prevent portions of the illumination light 12 from being transmitted in the direction of the detector 50. Further spectral conditioning of the detection light 17 to be detected by the detector 50 can be effected by the emission filter 18. The relay optics unit 32 forms an intermediate image plane 26 in which a field stop 28 serving to avoid an overlap of partial images in a sensor plane 52 of the detector 50 is arranged in the depicted exemplary embodiment. In the exemplary embodiment shown, the sensor plane 52 of the detector 50 is situated in an intermediate image plane, and consequently in a plane optically conjugate to the focal plane 16 of the microscope objective 20 and to the intermediate image plane 26.

FIG. 2 shows an exemplary illustration of partial images T01 to T37, which are generated by a multi-lens array 40 with 37 singlet lenses, in the sensor plane 52 of the detector 50. In the example shown, these 37 lenses should each have the same diameter and the same focal length. The distance at which the multi-lens array 40 is arranged relative to the sensor plane 52 is equal to this focal length of the lenses. In the example shown, a central lens 41, the optical axis of which coincides with the optical axis 60 of the microscope objective 20, is located on the optical axis 60 of the detection beam path. The partial image T01 in the sensor plane 52 is generated by this central lens 41.

The arrangement of a light-field microscope 100, which is illustrated in FIG. 1 and in which the multi-lens array 40 is arranged in a plane optically conjugate to the back focal plane 22 of the microscope objective 20, is also referred to as a Fourier light-field microscope. This arrangement of the multi-lens array 40 allows the partial images T01 to T37 measured by the detector 50 to be assigned to emission angles, which can be plenoptically combined by calculation in the example of fluorescence imaging shown here. The totality of the partial images T01, . . . , T37 of the sample 1 generated by one acquisition is referred to as an image data set.

In FIG. 2, let the x-axis run in the horizontal direction and the y-axis in the vertical direction. The z-axis coincides with the optical axis 60.

According to the invention, the control unit 90 serves to control the displacement device 15 and evaluate measurement data from the detector 50 and may be implemented by a PC, for example.

According to the invention, the control unit is initially configured
A) to control the displacement device 15 in such a way that image data sets T01, . . . , T37 of the sample 1 are successively acquired for in each case different relative positions between the microscope objective 20 and the sample 1,
B) to reconstruct a respective three-dimensional image stack V1, V2, V3 (see FIGS. 7, 8, 12, 13) of the sample 1 from the individual image data sets T01, . . . , T37.

Furthermore, the control unit 90 is configured
C) to control the displacement device 15 on the basis of a dependence of a magnification m(z) of the light-field microscope 100 on an axial coordinate z which runs parallel to the optical axis 60, in such a way that adjacent image stacks V1, V2, V3 (see FIGS. 7, 8, 12, 13) in the various relative positions in step A) overlap in part, and
D) to combine adjacent image stacks V1, V2, V3 (see FIGS. 7, 8, 12, 13) of the sample 1 to form a three-dimensional overall image of the sample 1 on the basis of a dependence of a magnification m(z) of the light-field microscope 100 on the axial coordinate z.

The light-field microscope 100 and, in particular, the control unit 90 may be configured to perform the method according to the invention or all or some of the variants of the method according to the invention described herein.

Examples thereof will be described below with reference to FIGS. 7 to 11 and 13.

Initially, the circumstances of the dependence of the magnification of the light-field microscope 100 on the axial coordinate z, which is essential for the invention, is explained with reference to FIGS. 3 to 5. FIG. 3 initially schematically illustrates a sample 1 with a test object 70 in the sample region 2. The test object 70 is intended to be a partially transparent rod with a constant square cross section over the direction of extent along the z-axis; see the coordinate system in FIG. 3. The edge length of the square cross section is provided with the reference sign a. Moreover, FIG. 3 schematically labels planes z1 and z8, which both extend in the xy-plane and are situated at different z-coordinates and hence at different axial depths. In the example described here, the plane z8 lies closer to the microscope objective 20 than the plane z1.

FIG. 4 shows a reconstructed image r(z1) of the z1-plane with a reconstructed cross section 75 of the test object 70, and FIG. 5 shows a reconstructed image r(z8) of the z8-plane, yet again with a reconstructed cross section 75 of the test object 70. For the example illustrated in FIGS. 3 to 5, the reconstruction algorithm is designed such that the number of pixels per image is the same in each case. This is evident from the images r(z1) and r(z8) in FIGS. 4 and 5, which each have 8 times 8 pixels represented as black dots. What is now important is that the edge length of the reconstructed cross section 75 is 2.5 grid constants of the pixel grid in the reconstructed plane r(z1), i.e. in FIG. 4, and hence smaller than the edge length of the reconstructed cross section 75 in the reconstructed plane r(z8), where the edge length is 4.5 grid constants of the pixel grid. This means that a larger field is propagated from the light-field microscope 100 to the detector 50 in the plane z1 than in the plane z8 or, in other words, the magnification m(z) is greater for the plane z8 than for the plane z1. Since the edge length a of the test object 70 is known to be constant, this also means that the number of pixels per unit area in the image r(z8) and in the plane z8 is greater than in the image r(z1) and in the plane z1.

The dependence of the magnification m(z) on the axial coordinate z can be determined using any of the methods explained in the general part of the description. For example, the dependence of the magnification m(z) on the axial coordinate z can be determined using the test object 70 as a calibration object.

In accordance with the theory, the magnification m(z) is linearly related to the axial coordinate z. In a preferred variant, a user can input parameters of the sample 1, for example the refractive index of an embedding medium in which the sample 1 is accommodated, and the control unit 90 can thereupon calculate the magnification m(z) using further parameters of the optical system, as explained in the general part of the description.

FIG. 6 once again illustrates the reconstructed test object 75 in a reconstructed image stack V, with it once again being evident that the edge length of the test object 75 is greater relative to the lateral extent of the image in the plane z8 than relative to the lateral extent of the image in the plane z1. It should be observed that the direction of the z-coordinate in FIG. 6 has been reversed in comparison with FIG. 3. The coordinate system between FIGS. 7 and 8 applies to each of FIGS. 6 to 8. If the assumption is made that the field stop 28 has a square cross section, then the reconstructed image stack V and hence also the imaged volume in the sample region 2 has the shape of a truncated pyramid with a square base.

An example of a lateral volume scan is explained with reference to FIG. 7. Illustrated there are image stacks V1, V2, V3 of the type shown in FIG. 6, which were reconstructed from three different image data sets of the sample 1. According to the invention, the image data sets that form the basis for the three image stacks V1, V2, V3 were acquired with different relative positions between the sample 1 and the microscope objective 20, with the different relative positions only differing with regard to the x-coordinate. To be more precise, the sample 1 was in each case displaced by an amount Δx in the x-direction using the xyz-displacement stage 15. The dependence of the magnification m(z) on the z-coordinate now leads to the displacement by Δx being sufficient to achieve an overlap of the image stacks where they have a large lateral extent. However, in regions 72 where the image stacks V1, V2, V3 have a smaller lateral extent, the images of adjacent image stacks no longer overlap. According to the invention, it is possible, in principle, to even generate an overall volume image of the sample 1 for image stacks V1, V2, V3 overlapping in this way.

However, using the dependence of the magnification m(z) on the axial coordinate z, it is also possible to determine a lateral displacement δx for the sequence of acquiring image data sets which ensures that the reconstructed image stacks V1, V2, V3 each overlap over the entire range of their axial extent. The volume arising due to the overlap of the image stacks is concave in that case.

In order to combine (stitch) an image z8V1 of the first image stack V1 with an image z8V2, located at the same axial depth z8, of the adjacent second image stack V2, it is necessary for the image z8V1 and the image z8V2 to be displaced relative to one another by δx. The displacement δx is measured in pixels and performed by the controller 90. Now, this lateral displacement δx measured in pixels is preferably calculated using the dependence of the magnification m(z) on the axial coordinate z, as determined according to any of the above-described methods.

This is performed for all pairwise adjacent images in all z-planes in FIG. 8, and the pairwise adjacent images are thus pushed onto one another. By preference, this is implemented in such a way that the images from one image stack, for example from the image stack V1, are left spatially unchanged and then, initially, the images from the image stack V2 and, subsequently, the images from the image stack V3 are suitably displaced and combined in each case. In the overall volume image of the sample 1 generated thus, the different planes still have the different scaling resulting from the dependence of the magnification m(z) on the axial coordinate. This means that the number of pixels per unit area is greater in the plane z8 than in the plane z1, as described above in the context of FIGS. 4 and 5.

Rescaling can be performed if this different scaling is undesirable. This rescaling is optional in the case of the purely lateral volume scan described here. Rescaling is mandatory for combining associated images from adjacent image stacks with one another in the case where the relative positions also differ in terms of their axial coordinates. We will return to this in the context of FIG. 13.

An example of rescaling is now described with reference to FIGS. 9 and 10. On the left-hand side, FIG. 9 shows the reconstructed image r(z1) from FIG. 4. On the left-hand side, FIG. 10 shows the reconstructed image r(z8) from FIG. 5. In the illustrations of FIGS. 9 and 10, the reconstructed test object 75 is illustrated the same size in each case. A comparison of the left-hand side of FIG. 9 with the left-hand side of FIG. 10 clearly demonstrates once again that r(z1) has a lower pixel density than r(z8). A rescaling transformation R is now configured to convert the image r(z8) into an identical image r′ (z8)=r(z8), as illustrated in FIG. 10. However, as shown in FIG. 9, the image r(z1) is converted by the rescaling transformation R into an image r′ (z1) which has a higher pixel density in comparison with the image r(z1), specifically the same pixel density as the image r′ (z8)=r(z8). Thus, the rescaling transformation R ensures that the pixel density is the same in all axial poses z and consequently becomes independent of the axial coordinate z.

In detail, rescaling can be implemented by interpolating between the pixel values reconstructed for a particular image. In principle, rescaling can be performed after the reconstruction. However, it is also possible to perform the reconstruction in such a way from the outset that the resultant image stacks have the sample pixel density in all planes.

It may also be expedient to displace a pixel grid in an image so that it is congruent with a pixel grid in an adjacent image to be combined with this image. This is explained with reference to FIG. 11.

FIG. 11a shows a first image z1V1 from a first image stack V1 and a second image z1V2 from a second image stack V2, which have already been displaced relative to one another by the correct amount in the x-direction and which overlap one another in a region ox′.

The first image z1V1 and the second image z1V2 each have a square pixel grid and the same number of pixels per unit area or, expressed differently, the same grid constant of the pixel grid or the same “pixel pitch”. It is evident from FIG. 11a that the pixel grid of the first image z1V1 is displaced relative to the pixel grid of the second image z1V2 by approximately half a grid constant of the pixel grid. However, for the purpose of combining the first image z1V1 and the second image z1V2, it is expedient for the pixel grids of the images to be combined to be coincident or congruent, i.e. for the pixels of the images to be combined to be located on the same two-dimensional grid. In order to achieve this, it is possible—as illustrated in FIG. 11b—for the first image z1V1 to be subjected to a transformation F that transforms the image z1V1 into an image z1V1′, in which the pixel grid has been displaced by a suitable amount in the x-direction. The transformation F calculates the image values at the respective positions of the image z1V1′ by interpolation of the measurement data at the positions of the pixels in the image z1V1. FIG. 11c illustrates the overlaid images z1V2 and z1V1′ and shows that the pixel grids are now congruent, i.e. that the combined images z1V2 and z1V1′ have a common pixel grid.

FIG. 12 illustrates image stacks V1, V2 and V3 which are offset only axially relative to one another by an amount Δz. Since an axial height h of the image stacks V1, V2 and V3 is smaller than Δz, there is a respective axial gap between V1 and V2 on the one hand and V2 and V3 on the other hand. Since the image stacks V1, V2 and V3 consequently do not overlap, the image sequence in FIG. 12 is not suitable for producing an overall volume image of the sample 1.

This means that, for a purely axial volume scan, an offset oz of the relative positions for the acquisition of the individual image data sets must be smaller than the axial height h of the reconstructed image stacks. This is illustrated in FIG. 13. What should be considered here is that the axial scaling of the z-displacement of the light-field microscope generally deviates from the axial scaling of the reconstructed image stacks. However, the axial scaling of the z-displacement of the light-field microscope is related linearly to the axial scaling of the reconstructed image stacks. This calibration relationship, i.e. the constant of proportionality, can be determined using any of the methods explained in the general part of the description.

Should the axial calibration relationship be known, the related images from different image stacks, which belong to the same axial plane in the sample and which should therefore be combined, can be ascertained.

On account of the facts explained above in connection with FIGS. 4 and 5, it is clear that, given an axial volume scan of the type illustrated in FIG. 13, the intention is to combine images which belong to different image stacks and which have different pixel densities, i.e. which have a different “pixel pitch”. It is thus necessary to perform rescaling of the type described above in connection with FIG. 10 for these images such that all images to be linked to one another have the same pixel grid.

The present invention provides a novel method for light-field microscopy and a novel light-field microscope, which allow large volume images of a sample to be acquired without much outlay.

### LIST OF REFERENCE SIGNS

1 Sample
2 Sample region
10 Light source
12 Illumination light
13 Excitation filter
14 Main beam splitter
15 Displacement device, xyz-displacement stage
16 Sample plane, object plane, focal plane of the microscope objective 20
17 Light coming from the sample 1
18 Emission filter
20 Microscope objective
22 Back focal plane of the microscope objective 20, pupil plane
24 Tube lens, first lens of the relay optics unit 32
26 Intermediate image plane
28 Field stop
30 Lens, second lens of the relay optics unit 32
32 Relay optics unit
34 Plane optically conjugate to the back focal plane 22 of the microscope objective
20, pupil plane
40 Multi-lens array
41 Central lens of the multi-lens array 40
50 Two-dimensionally spatially resolving detector, camera
52 Sensor plane of the camera, optically conjugate to the plane 16 in the sample 1 and to the plane 26
60 Optical axis of the detection beam path
70 Object with a constant square cross section in sample 1
72 Overlap-free volume regions between the reconstructed images V1 and V2 on the one hand and V2 and V3 on the other hand
75 Reconstructed image of the object 70
90 Control unit
100 Apparatus according to the invention
a Side length of test object 70
F Interpolation operation
r(z1) Reconstructed image of the test object 70 in the plane z1
r(z8) Reconstructed image of the test object 70 in the plane z8
R Scaling operation
T01 to T37 Partial images
h Extent of the reconstructed three-dimensional images V1, V2, V3 of the sample 1 in the z-direction
V Reconstructed three-dimensional image of the sample 1
V1 First reconstructed three-dimensional image of the sample 1
V2 Second reconstructed three-dimensional image of the sample 1
V3 Third reconstructed three-dimensional image of the sample 1
x, y, z Coordinate axes
z1 Image in the uppermost z-plane of a reconstructed three-dimensional image
z1′ Image z1 after performing the scaling operation R
z1V1 Image in the uppermost z-plane of image V1
z1V2 Image in the uppermost z-plane of image V2
z1V2′ Image z1V2 after performing the interpolation operation F
z8 Image in the lowermost z-plane of image stacks
z8′ Image z8 after performing the scaling operation R
Δx Displacement of the reconstructed images V1, V2, V3 in the x-direction
δx Displacement of the reconstructed images V1, V2, V3 in the x-direction
δx Overlap of z1V1 and z1V2 on the one hand and of z1V1 and z1V2′ on the other hand in the x-direction
Δz Displacement of the reconstructed images V1, V2, V3 in the z-direction
δz Displacement of the reconstructed images V1, V2, V3 in the z-direction

### REFERENCES

[1] DE 10 2022 128 078 A1

1. A method for light-field microscopy, comprising:
a) successively acquiring image data sets of a sample using a light-field microscope at in each case different relative positions between a microscope objective of the light-field microscope and the sample,
b) reconstructing a respective image stack of the sample from the various image data sets,
c) wherein the various relative positions in step a) are chosen on the basis of a dependence of a magnification of the light-field microscope on an axial coordinate which runs parallel to the optical axis, in such a way that adjacent image stacks overlap in part, and
d) wherein adjacent image stacks of the sample are combined to form a three-dimensional overall image of the sample on the basis of a dependence of a magnification of the light-field microscope on the axial coordinate.

2. Method according to claim 1,
wherein
the dependence of the magnification on the axial coordinate is calculated from optical parameters of the light-field microscope and/or of the sample.

3. Method according to claim 2,
wherein
the optical parameters of the light-field microscope include one or more of the following parameters:
the refractive index of an embedding medium in which the sample is received,
the magnification of the microscope objective,
the numerical aperture of the microscope objective,
the axial distance of a sample-side exit lens of the microscope objective from the sample,
the refractive index of an immersion liquid,
parameters of the geometric arrangement of a multi-lens array.

4. Method according to claim 1,
wherein
the dependence of the magnification on the axial coordinate is determined using a calibration sample, the size of which is known and/or which comprises structures of known size, at multiple different axial distances of the microscope objective relative to the calibration sample.

5. Method according to claim 1,
wherein
the dependence of the magnification on the axial coordinate is determined by analysis of axially and laterally overlapping images.

6. Method according to claim 1,
wherein
different methods for determining the dependence of the magnification on the axial coordinate are combined.

7. Method according to claim 1,
wherein
in step c), the various relative positions are chosen in such a way that adjacent image stacks overlap at least in part in an axial coordinate and that wherever the adjacent image stacks overlap in the axial coordinate, they overlap at least in part in both lateral coordinates perpendicular to the axial coordinate.

8. Method according to claim 1,
wherein
a relative position between the sample and the microscope objective is changed in the coordinates perpendicular to the optical axis.

9. Method according to claim 1,
wherein
a relative position between the sample and the microscope objective is changed in the axial coordinate parallel to the direction of the optical axis.

10. Method according to claim 1,
wherein
a calibration relationship is determined between an axial scaling of a reconstructed image stack and an axial scaling of an axial displacement of a displacement device for adjusting an axial distance between the sample and the microscope objective.

11. Method according to claim 10,
wherein
an axial scaling of the reconstructed image stack is calibrated using the ascertained calibration relationship, wherein the calibration of the axial scaling is performed following the reconstruction of the three-dimensional images or in the course of the reconstruction of the three-dimensional images.

12. Method according to claim 10,
wherein
the axial scaling of the axial displacement of the displacement device is calibrated using the ascertained calibration relationship.

13. Method according to claim 10,
wherein
the calibration relationship is calculated from optical parameters of the light-field microscope and/or of the sample.

14. Method according to claim 10,
wherein
the calibration relationship is determined by analysis of axially and laterally overlapping images.

15. Method according to claim 10,
wherein
the calibration relationship is ascertained using a calibration object which has axial structuring of known size and by reconstruction of image stacks acquired at different axial distances of the microscope objective relative to the calibration object.

16. Method according to claim 1,
wherein
in order to combine a first image in a first image stack with a second image which is in an adjacent second image stack, the first image and the second image are displaced relative to each other by a lateral displacement that corresponds to the different relative position between the sample and the microscope objective when acquiring the image data set for the second image stack in comparison with the acquisition of the image data set for the first image stack,
the lateral displacement measured in pixels is calculated using the dependence of the magnification on the axial coordinate, and
the lateral displacement measured in pixels is calculated.

17. Method according to claim 1,
wherein
a pixel grid of the images in an image stack is rescaled in such a way using the dependence of the magnification on the axial coordinate that the number of pixels per unit area is the same for all images in this image stack.

18. Method according to claim 17,
wherein
the rescaling is performed after the reconstruction of the three-dimensional images.

19. Method according to claim 17,
wherein
the rescaling is performed in the course of the reconstruction of the three-dimensional images.

20. Method according to claim 1,
wherein
in order to combine a first image belonging to a first image stack to a second image belonging to a second image stack and having the same number of pixels per unit area as the first image, the pixel grid of the first image is matched to the pixel grid of the second image by interpolation between measured pixel values reconstructed for the first image stack, in such a way that the first image and the second image have a congruent pixel grid in a lateral relative position correct for the combination.

21. Light-field microscope, comprising:
a light source for providing illumination light,
an illumination beam path for guiding the illumination light into a sample region,
a two-dimensionally spatially resolving detector for detecting detection light coming from a sample in the sample region,
a detection beam path with a microscope objective and a multi-lens array for guiding the detection light to the detector,
a displacement device for adjusting a relative position between the sample and the microscope objective in the direction of an optical axis of the microscope objective and/or in the direction of at least one lateral direction perpendicular thereto and
a control unit for controlling the displacement device and for evaluating measurement data from the detector, wherein the control unit is configured
A) to control the displacement device in such a way that image data sets of the sample are successively acquired for in each case different relative positions between the microscope objective and the sample,
B) to reconstruct a respective three-dimensional image stack of the sample from the individual image data sets (T01, . . . , T37),
C) to control the displacement device on the basis of a dependence of a magnification of the light-field microscope on an axial coordinate which runs parallel to the optical axis, in such a way that adjacent image stacks in the various relative positions in step A) overlap in part, and
D) to combine adjacent image stacks of the sample to form a three-dimensional overall image of the sample on the basis of a dependence of a magnification of the light-field microscope on the axial coordinate.

22. Light-field microscope according to claim 21,
wherein
the displacement device is formed by an xyz-displacement stage.

23. Light-field microscope according to claim 21,
wherein
the multi-lens array is arranged upstream of the detector in a plane optically conjugate to a back focal plane of the microscope objective or in the vicinity of such a plane.

24. Light-field microscope according to claim 21, configured to perform a method comprising:
a) successively acquiring image data sets of a sample using a light-field microscope at in each case different relative positions between a microscope objective of the light-field microscope and the sample,
b) reconstructing a respective image stack of the sample from the various image data sets,
c) wherein the various relative positions in step a) are chosen on the basis of a dependence of a magnification of the light-field microscope on an axial coordinate which runs parallel to the optical axis, in such a way that adjacent image stacks overlap in part, and
d) wherein adjacent image stacks of the sample are combined to form a three-dimensional overall image of the sample on the basis of a dependence of a magnification of the light-field microscope on the axial coordinate.
